(19) United States
(12) Patent Application Publication
(10) Pub. No.: US 2014/0147273 A1
(43) Pub. Date: May 29, 2014

(54) Wind Turbine

(71) Applicant: Oztren Industries Pty.Ltd, Port Lincoln (AU)

(72) Inventor: Micheal Charles Trenberth, Tumby Bay (AU)

(73) Assignee: Oztren Industries Pty.Ltd, Port Lincoln (AU)

(21) Appl. No.: 14/092,378

(22) Filed: Nov. 27, 2013

Related U.S. Application Data
(60) Provisional application No. 61/730,197, filed on Nov. 27, 2012.

(51) Int. Cl. F03D 7/06

(52) U.S. Cl. CPC F03D 7/06
USPC 416/1; 416/62

(57) ABSTRACT

A wind turbine having a speed control system. The wind turbine has a control system using weights positioned on its rotating blades. The blades are biased such that the blades are kept open during normal operation and closed when a pre-selected rotational is exceeded.

### CROSS-REFERENCE TO RELATED APPLICATIONS

This application claims priority to and the benefit of the filing of U.S. Provisional Patent Application Ser. No. 61/730,197, entitled “Vertical Wind Turbine”, filed on Nov. 27, 2012, and the specification and claims thereof are incorporated herein by reference.

### BACKGROUND OF THE INVENTION

1. Field of the Invention (Technical Field)

Embodiments of the present invention relate to wind turbines. More particularly to speed control of wind turbines in windy conditions.

2. Description of Related Art

Existing wind turbines, especially vertical wind turbines, exhibit a tendency toward self-destruction in high winds. Existing vertical wind turbine designs usually use centrifugal force to change the pitch of the turbine blades. This control technique causes the blades of the turbine to pulse open and closed in wind gusts or high sustained wind speeds, leading to the point of self-destruction due to high centrifugal force created by high rotational velocity. There is thus a present need for a method and apparatus which provides better control of blade pitch adjustments in windy conditions.

### BRIEF SUMMARY OF THE INVENTION

Embodiments of the present invention relate to a wind turbine having a rotatable shaft having opposed ends, a load connected to one end of the rotatable shaft and driven by the rotatable shaft, at least one support arm connected to the rotatable shaft, at least one blade attached to the support arm and extending along the rotatable shaft, and at least one weight fastened to the blade and positioned on the blade to maintain an equalized state for the blade during rotation. The weight can be positioned on the blade to project away from the blade. The weight can be biased to allow the blade to be completely open during normal operation and completely closed at a pre-selected rotational velocity. The bias can be set to allow the blade to automatically re-open after closing. The wind turbine can be positioned such that the blades rotate about an axis which is substantially vertical or which is substantially horizontal. The load can include a direct and/or alternating current electricity generator and/or a pump for liquids. In one embodiment, at least a pair of support arms can be connected to opposed ends of the rotatable shaft. A plurality of blades can be provided and the blades can be positioned symmetrically around the rotatable shaft. Each blade can include at least one weight.

In one embodiment, the turbine can also include a plurality of support arms arranged such that one support arm is disposed at each end of the rotatable shaft for each of the plurality of blades, a first set of gears can be mounted on each support arm, a support shaft can be provided on each support arm carrying the blades, and a second set of gears can be mounted on the blades and configured to mesh with the first set of gears.

The wind turbine can also include a collar secured to the rotatable shaft and positioned to contact the blades when the blades are fully open to control the range of motion of the blades. The blade can have an air foil shape with a curved leading edge tapering to a trailing edge. The turbine can also include a shock absorber and spring mounted on the support arm to compress when contacted by the blade in a wind gust situation and return the blade to an open position after the gust.

In one embodiment, the wind turbine can also include a load temperature sensor to de-couple the load from the rotatable shaft when a pre-selected temperature is exceeded. The wind turbine can also include a locking pin, carried by the support arm, and configured to lock the blade in a closed position in extreme wind conditions.

Embodiments of the present invention also relate to a method for control of blade pitch in a wind turbine including mounting a driveshaft for rotation; driving a load with the driveshaft; attaching at least one blade to the rotatable shaft; attaching at least one weight to the blade; and biasing the position of the weight on the blade to cause the blade to be completely open during normal operation and closed at a preselected over-speed. The method can also include locking the blade in a closed position when the preselected over-speed is exceeded and releasing the blade from the closed position when the speed is reduced to an amount less than the preselected over-speed. The method can also include setting a temperature overload point for the load, monitoring the temperature of the load, and releasing the load from the driveshaft when the temperature overload point is reached. In one embodiment, the method can include reconnecting the load to the driveshaft when the temperature of the load falls below the temperature overload point.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a side view illustrating a vertical axis turbine in accordance with an embodiment of the present invention;

FIG. 2 is a perspective view drawing which illustrates a blade carrier assembly according to an embodiment of the present invention;

FIGS. 3 and 4 are top-view drawings of an embodiment of the present invention wherein the blades are respectively illustrated in open and closed positions; and

FIGS. 5 and 6 are drawings which illustrate a safety latching pin according to an embodiment of the present invention.

### DETAILED DESCRIPTION OF THE INVENTION

Although embodiments of the present invention relate to a turbine having an applied load in the form of an electric generator embodiments of the present invention are equally-applicable to other loads. Thus, the term “generator” as used throughout this application is intended to mean a generator or any other type of load which can be powered from a turbine, including but not limited to one or more pumps.

In an embodiment of the present invention, the blades are preferably pitched by a compounding of inertial kinetic energy stored in projected weights carried by the blades. This occurs due to variable loads being applied to the main drive shaft from a DC generator and/or an AC alternator. When a pre-selected rotational velocity is reached, the combination of wind force, generator and alternator load, and the compounding of inertial kinetic energy stored in the weighted blades carry the blades forward in a synchronized motion to initiate movement of the blades around their pivot points. This slows the turbine and allows the blades to reopen. This operation allows the turbine to remain open in high wind conditions generating power, dynamically feathering the blades in gusty conditions. This feathering occurs when the load on the shaft is exceeded by the wind force pushing on the blades, dynamically adjusting the balance point. This feathers the blades, reducing the intercepted wind energy and slows the turbine. A small shock absorber and/or spring or other resilient mechanism can return the blades to the open position. Gear sets attached to the blades insure uniform and coordinated movement of the blades. For an extra safety feature, a positive failsafe lock may be incorporated in an over-run situation where the DC generator and/or AC alternator are at maximum load and beginning to overheat, a thermal circuit breaker can release the alternator load on the drive shaft which is driven by the turbine blades. This allows the blades to accelerate. This action causes feathering of the blades firstly, then transitions to centrifugal force in the arc of movement to completely close the blades. When in the fully closed position, a spring loaded pin may drop into holes in the gear sets and support arms, locking the entire blade and gear assembly in the fully closed position. When weather conditions return to normal, the pin can be pulled either manually, electronically, or via some mechanical configuration. The shock absorber/spring mechanism then preferably returns the blades to the open position for normal operation.

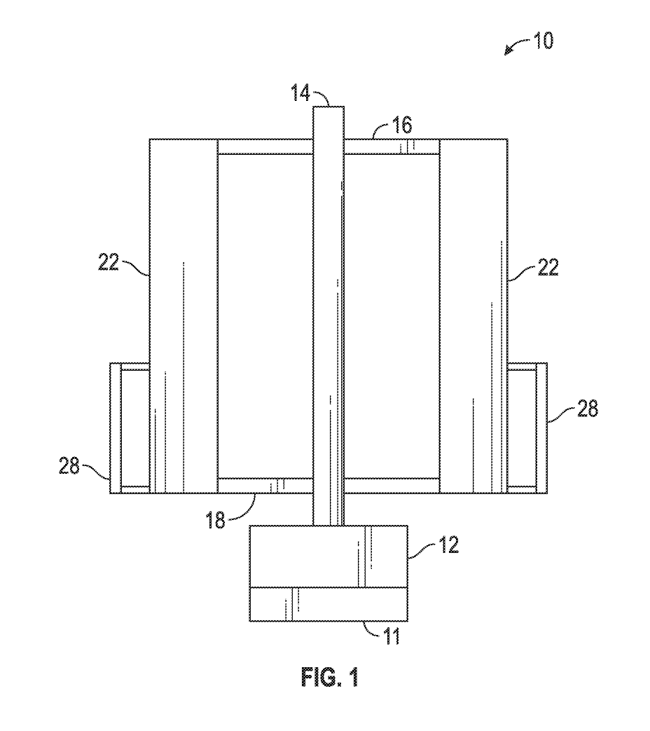

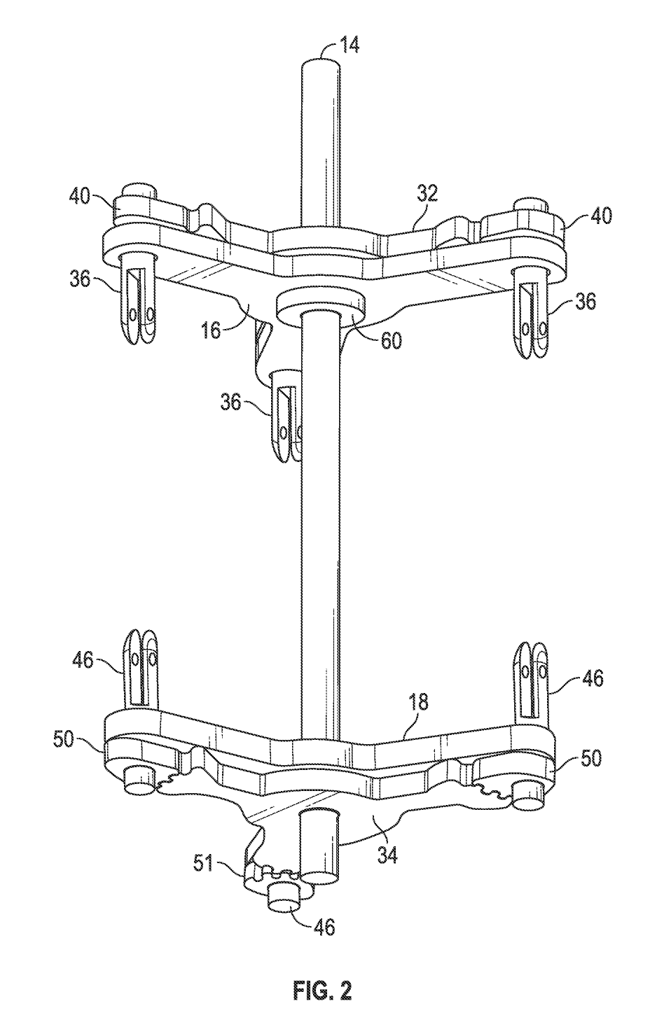

FIG. 1 illustrates, in schematic form, an embodiment of wind turbine 10. In this embodiment, wind turbine 10 preferably includes electricity generator 12 which is driven by vertical shaft 14 that is rotatably mounted to generator 12. Attached to shaft 14 is upper support arm 16 and lower support arm 18. Support arms 16 and 18 are preferably fixedly secured to shaft 14 and rotate with it. One or more blades 22 are preferably attached to end portions of support arms 16 and 18. One or more weights 28 are preferably attached to each of blades 22. In one embodiment, the weights are preferably positioned such that they project away from the blades. Weights 28 are preferably selected and disposed so as to hold blades 22 in an equalized state during rotation, cancelling both centrifugal and centripetal forces. This balance point is slightly biased, optionally by at least one degree, thus allowing centrifugal force to hold blades 22 completely in the open position against a gear set (see FIG. 2) at operating velocity. In one embodiment, generator 12 can include a thermal circuit breaker 11. Thermal circuit breaker 11 can be pre-set to a maximum allowed temperature for generator 12. Because an overheat situation can occur when shaft 14 rotates too fast due to strong winds, thermal circuit breaker 11 can optionally be configured to release the generator on shaft 14. This then allows blades 22 to be closed.

FIG. 2 illustrates, in more detail, an embodiment of a mounting system for blades 22. Blades 22 are not shown in FIG. 2 so that the mounting system may be more easily seen. Although the figures in this application illustrate an embodiment wherein three blades are provided, desirable results can be achieved with other numbers of blades. In one embodiment, the blades which are used are preferably arranged symmetrically about the perimeter of shaft 14 so as to provide a balanced configuration. Because the figures illustrate an embodiment wherein three blades are provided, in FIG. 2, upper arm 16 and lower arm 18 are seen to have three lobes, each lobe carrying a turbine blade. Upper gear set 32 and lower gear set 34 are preferably carried by upper arm 16 and lower arm 18 respectively. Upper support shafts 36 extend through upper support arm 16 and are mounted for rotation with respect to upper support arm 16. Upper support shafts 36 are preferably connected to upper blade gears 40 that mesh with upper gear set 32.

As best illustrated in FIG. 2, upper blade gears 40 are connected to upper support shaft 36 and are positioned to interact with upper gear set 32. The meshing of upper gear set 32 with corresponding upper blade gears 40 preferably provides uniform and controlled movement of blades 22. Lower support shafts 46 are also preferably provided which extend through lower support arm 18 and connect to a lower portion of blades 22. As such, blades 22 are held between upper support shafts 36 and lower support shafts 46. Although not essential, lower support shafts 46 are preferably attached to lower blade gears 50 which mesh with lower gear set 34. The result of this arrangement is to keep movement of the turbine blades in synchronism and control the inward movement of the blades. The various gears act to control the opening and closing of blades 22.

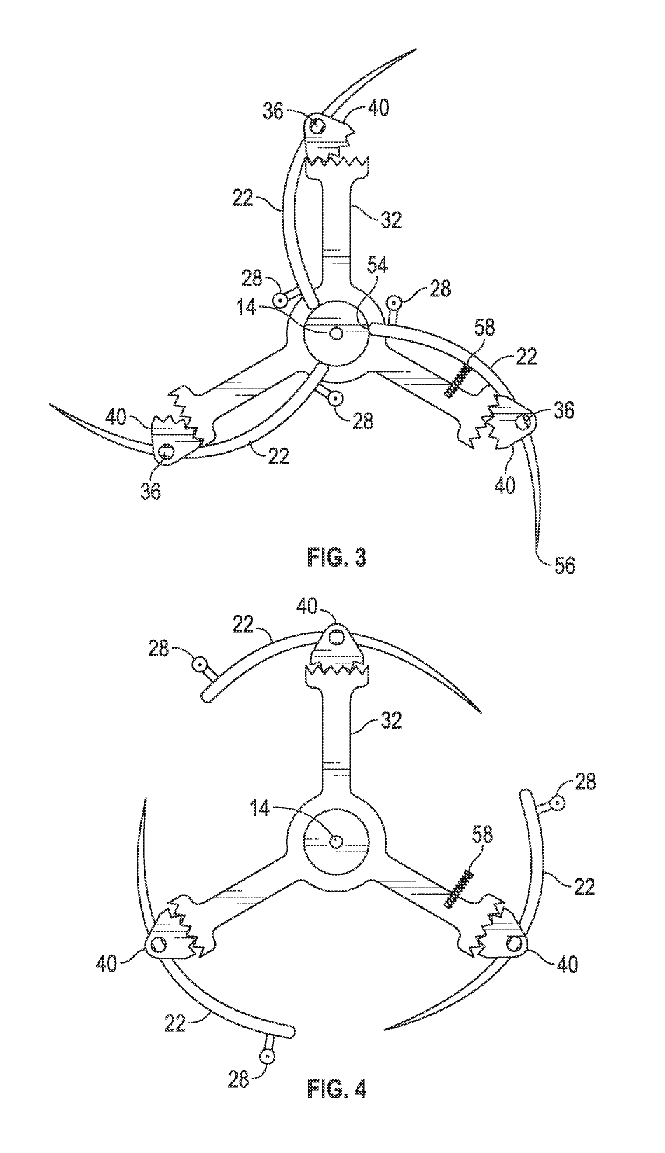

FIG. 3 is a top view which illustrates blades, 22 arranged substantially symmetrically around shaft 14. Blades 22 are preferably at least substantially identical, having an airfoil shape with curved leading edge 54 tapering to trailing edge 56. FIG. 3 shows clearly how upper gear set 32 meshes with upper blade gears 40. This view illustrates how upper blade gears 40 interact with gear set 32 to control the range of motion of blades 22. In FIG. 3, blades 22 are fully open to allow for maximum rotational speed. Shock absorber and spring 58 are at rest in the completely open position and under no tension. Shock absorber and spring 58 compress when nearest blade 22 pitches and serves to return all of blades 22 to the open position in a wind gust with no load on shaft 14. FIG. 4 shows blades 22 in a closed or feathered position where shaft 14 will not be driven.

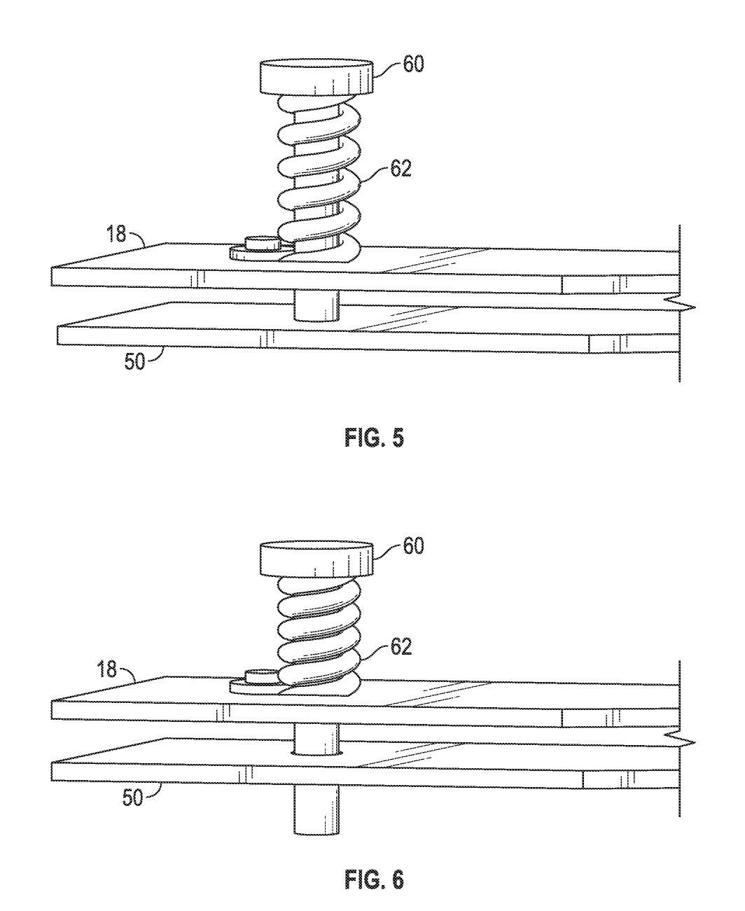

FIGS. 5 and 6 are schematic views illustrating a locking mechanism for turbine 10. Spring loaded pin 60, preferably biased by spring 62, acts as a locking mechanism when blades 22 reach a fully closed position. This prevents blades 22 from re-opening in extreme wind conditions. Pin 60 can be mounted on, for example, lower arm 18 and preferably slides over one of lower blade gears 50 as blades 22 move. Normally, as illustrated in FIG. 5, pin 60 is held up by contact with lower blade gear 50. When blades 22 close, pin 60 is aligned with an opening in lower blade gear 50 and drops into this opening as illustrated in FIG. 6. At this point, blades 22 are locked closed because lower blade gear 50 cannot move. Pin 60 may be manually and/or automatically (via an electromagnetic and/or mechanical lifting mechanism) re-set to allow renewed operation of turbine 10.

Although the figures illustrate a vertical axis orientation, desirable results can also be achieved when it is disposed in a non-vertical orientation. Although the figures illustrate an embodiment wherein both upper gear set 32 and lower gear set 34 are provided, desirable results can be achieved with only one of these gear sets. Optionally, in lieu of or in addition to upper and lower gear sets, one or more gear sets can be disposed somewhere along the length of blades 22, such that in interfacing gear, which can be similar to upper or lower blade gears 40 or 50 can be incorporated into blades 22 or otherwise attached to them. In other words, although the figures illustrate an embodiment of the present invention wherein both upper and lower gear sets are provided at the terminal ends of the blades, desirable results can be achieved with any one or more such gear sets and such gear sets need not necessarily be disposed at the ends of the blades, but rather can be disposed anywhere along the length of the blades or can be disposed at the ends of the blades.

As best illustrated in FIG. 2, an embodiment of the present invention provides two assemblies (a first formed from upper and lower support arms 16 and 18 and the second formed from upper and lower gear sets 32 and 34) which rotate about a common axis (shaft 14). This arrangement assures that blades 22 move in unison. For example, rotation of any one of gears 40 by a few degrees moves its corresponding blade 22 by a corresponding amount. Because all of the gear faces on gear sets 32 and 34 are connected, movement of any one of gears 40 will cause a corresponding movement of all other gears 40. Thus, all of blades 22 operate in unison. Although the foregoing description describes the use of interfacing gear sets to effect the uniform movement between all of the blades, any other mechanism can be used in order to effect the simultaneous movement of all of the blades. Thus, in one embodiment, cams and lobes, chain and sprockets, electric drive motors and sensors combinations thereof and the like can be used in conjunction with or in place of the interfacing gear sets. Therefore, in one embodiment of the present invention, the terms “gear” and “gear set” include any of these alternative synchronizing mechanisms. Collar 60 is preferably secured to shaft 14 and acts as a stop to limit the range of motion of blades 22. This is because leading edge 54 of blades 22 come into contact with collar 60 when blades 22 are fully open.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A wind turbine comprising:
a rotatable shaft having opposed ends;
a load connected to one end of said rotatable shaft and driven by said rotatable shaft;
at least one support arm connected to said rotatable shaft;
at least one blade attached to said support arm and extending along said rotatable shaft; and
at least one weight fastened to said blade and positioned on said blade to maintain an equalized state for said blade during rotation.

2. The wind turbine of claim 1 wherein said weight is positioned on said blade to project away from said blade.

3. The wind turbine of claim 2 wherein said weight is biased to allow said blade to be completely open during normal operation and completely closed at a pre-selected rotational velocity.

4. The wind turbine of claim 3 wherein said bias is set to allow said blade to automatically re-open after closing.

5. The wind turbine of claim 1 wherein said wind turbine is positioned such that said blades rotate about an axis which is substantially vertical.

6. The wind turbine of claim 1 wherein said wind turbine is positioned such that said blades rotate about an axis which is substantially horizontal.

7. The wind turbine of claim 1 wherein said load comprises a direct current electricity generator.

8. The wind turbine of claim 1 wherein said load comprises an alternating current electricity generator.

9. The wind turbine of claim 1 wherein said load comprises a pump for liquids.

10. The wind turbine of claim 1 further comprising at least a pair of support arms connected to opposed ends of said rotatable shaft.

11. The wind turbine of claim 10 further comprising a plurality of blades, said blades positioned symmetrically around said rotatable shaft, each blade comprising at least one weight.

12. The wind turbine of claim 11 further comprising:
a plurality of support arms arranged such that one support arm is disposed at each end of said rotatable shaft for each of said plurality of blades;
a first set of gears mounted on each support arm;
a support shaft on each support arm carrying said blades; and
a second set of gears, mounted on said blades and meshing with said first set of gears.

13. The wind turbine of claim 12 further comprising a collar secured to said rotatable shaft and positioned to contact said blades when said blades are fully open to control the range of motion of said blades.

14. The wind turbine of claim 1 wherein said blade has an air foil shape with a curved leading edge tapering to a trailing edge.

15. The wind turbine of claim 1 further comprising a shock absorber and spring mounted on said support arm to compress when contacted by said blade in a wind gust situation and return said blade to an open position after the gust.

16. The wind turbine of claim 1 further comprising a load temperature sensor to de-couple said load from said rotatable shaft when a pre-selected temperature is exceeded.

17. The wind turbine of claim 1 further comprising a locking pin, carried by said support arm, and configured to lock said blade in a closed position in extreme wind conditions.

18. A method for control of blade pitch in a wind turbine comprising:
mounting a driveshaft for rotation;
driving a load with the driveshaft;
attaching at least one blade to the rotatable shaft;
attaching at least one weight to the blade; and
biasing the position of the weight on the blade to cause the blade to be completely open during normal operation and closed at a preselected over-speed.

19. The method of claim 18 further comprising:
locking the blade in a closed position when the preselected over-speed is exceeded; and
releasing the blade from the closed position when the speed is reduced to an amount less than the preselected over-speed.

20. The method of claim 18 further comprising:
setting a temperature overload point for the load;
monitoring the temperature of the load; and
releasing the load from the driveshaft when the temperature overload point is reached.

21. The method of claim 20 further comprising reconnecting the load to the driveshaft when the temperature of the load falls below the temperature overload point.
